(19) United States
(12) Patent Application Publication
(10) Pub. No.: US 2026/0103100 A1
(43) Pub. Date: Apr. 16, 2026

(54) ULTRACAPACITOR TENDER SYSTEMS AND METHODS

(71) Applicant: Richardson Electronics, Ltd., LaFox, IL (US)

(72) Inventors: Brian Christopher Gumino, LaFox, IL (US); John Raymond Curran, LaFox, IL (US)

(21) Appl. No.: 18/915,977

(22) Filed: Oct. 15, 2024

(51) Int. Cl. B60L 53/55; B60L 53/53; B60L 53/62

(52) U.S. Cl. CPC B60L 53/55; B60L 53/53; B60L 53/62; B60L 2210/12; B60L 2210/14

(57) ABSTRACT

Systems, methods, and computer-readable media for tendering an ultracapacitor module. A system includes an ultracapacitor module comprising at least one ultracapacitor, wherein the ultracapacitor module is electrically coupled to an external system, such that the ultracapacitor module provides power to the external system for selectively powering the external system, a power source electrically coupled to the ultracapacitor module the power source storing an energy supply and providing the energy supply to the ultracapacitor module, and a DC-to-DC converter for transferring the energy supply from the power source and to the ultracapacitor module. The system includes a controller comprising instructions for a method comprising measuring a voltage of the ultracapacitor module, comparing the voltage of the ultracapacitor module to a voltage threshold, and if the voltage of the at least one ultracapacitor is less than the voltage threshold, transferring the energy supply from the power source to the ultracapacitor module.

### BACKGROUND

### 1. FIELD

Embodiments of the present disclosure relate to energy storage systems. More specifically, embodiments of the present disclosure relate to energy storage systems using ultracapacitors.

### 2. RELATED ART

Ultracapacitors (e.g., supercapacitors) have many useful applications and may outperform traditional power sources (including batteries and rechargeable batteries) in some contexts. For example, compared to typical power sources, ultracapacitors can recharge and provide energy at a much faster rate and have a greater tolerance for discharge and charge cycles. These benefits make ultracapacitors particularly useful in some applications, including in automobiles, locomotives, recreational vehicles, and other vehicle systems. For example, ultracapacitors may provide quick power to vehicle systems, which may aid in the startup process.

Despite the many benefits of ultracapacitors, several drawbacks may make them unideal for certain use cases. One such issue is the tendency for ultracapacitors to experience voltage drops due to discharge. For example, in a situation where the system utilizing the ultracapacitors has not been used in a while, the ultracapacitors may experience significant discharge, leaving them unable to serve as an energy source for a system needing an energy source. In such an example, there may be a significant risk in using ultracapacitor modules in an environment lacking readily available alternative sources of power. Therefore, there is a need for systems and methods of maintaining the energy supply of ultracapacitor modules.

### SUMMARY

In some aspects, the techniques described herein relate to a tender system including: an ultracapacitor module including at least one ultracapacitor, wherein the ultracapacitor module is electrically coupled to an external system, such that the ultracapacitor module provides power to the external system for selectively powering the external system ; a power source electrically coupled to the ultracapacitor module the power source storing an energy supply and providing the energy supply to the ultracapacitor module; a DC-to-DC converter for transferring the energy supply from the power source and to the ultracapacitor module; and a controller including at least one non-transitory computer-readable media including computer-executable instructions that, when executed by at least one processor, perform a method of managing the ultracapacitor module and the power source, the method including: measuring a voltage of the ultracapacitor module; comparing the voltage of the ultracapacitor module to a voltage threshold; and if the voltage of the at least one ultracapacitor is less than the voltage threshold, transferring, using the DC-to-DC converter, the energy supply from the power source to the ultracapacitor module.

In some aspects, the techniques described herein relate to a tender system, wherein the method further includes: measuring a second voltage of the ultracapacitor module, wherein the voltage is a first voltage; comparing the second voltage to a second voltage threshold, wherein the voltage threshold is a first voltage threshold and the second voltage threshold is greater than the first voltage threshold; and if the second voltage is greater than or equal to the second voltage threshold, stopping transfer of the energy supply from the power source to the ultracapacitor module.

In some aspects, the techniques described herein relate to a tender system, wherein the DC-to-DC converter decreases an energy supply voltage such that the energy supply voltage is less than or equal to a voltage rating of the ultracapacitor module.

In some aspects, the techniques described herein relate to a tender system, further including: a second DC-to-DC converter facilitates a transfer of a recharging energy supply from the external system to the power source, wherein the DC-to-DC converter is a first DC-to-DC converter.

In some aspects, the techniques described herein relate to a tender system, wherein the power source is at least one of a battery, a lithium-ion (LiO) battery, a lithium iron phosphate (LiFePO4) battery, a lead-acid battery, or a rechargeable battery.

In some aspects, the techniques described herein relate to a tender system, wherein the external system is at least one of an automobile, a locomotive, a snowmobile, a utility task vehicle (UTV), an all-terrain vehicle (ATV), a golf cart, or a recreational vehicle.

In some aspects, the techniques described herein relate to a tender system, wherein the method further includes: measuring a power source voltage associated with the power source; and if the power source voltage falls below a power source voltage threshold, transmitting an indication to the external system.

In some aspects, the techniques described herein relate to a tender system including: an ultracapacitor module including at least one ultracapacitor, wherein the ultracapacitor module is electrically coupled to an external system, such that the ultracapacitor module provides power to the external system for selectively powering the external system; a power source electrically coupled to the ultracapacitor module the power source storing an energy supply and providing the energy supply to the ultracapacitor module; one or more DC-to-DC converters for transferring the energy supply from the power source and to the ultracapacitor module; and one or more non-transitory computer-readable media including computer-executable instructions that, when executed by at least one processor, perform a method of managing the ultracapacitor module and the power source, the method including: measuring a voltage of the ultracapacitor module; comparing the voltage of the ultracapacitor module to a voltage threshold; and if the voltage of the ultracapacitor module is less than the voltage threshold, transferring, using the one or more DC-to-DC converters, at least a portion of the energy supply from the power source to the ultracapacitor module.

In some aspects, the techniques described herein relate to a tender system, wherein the external system includes an external charging module configured to provide a second energy supply to at least one of the ultracapacitor module or the power source, wherein the energy supply is a first energy supply.

In some aspects, the techniques described herein relate to a tender system, wherein the external charging module is an alternator.

In some aspects, the techniques described herein relate to a tender system, wherein the method further includes: determining a state of the external system; and if the state of the external system is a powered on state, initiating transfer of a second supply via an external charging module associated with the external system to the ultracapacitor module such that the ultracapacitor module recharges, wherein the energy supply is a first energy supply.

In some aspects, the techniques described herein relate to a tender system, wherein the one or more DC-to-DC converters includes: a first DC-to-DC converter configured to regulate a first voltage between the power source and the ultracapacitor module; a second DC-to-DC converter configured to regulate a second voltage between the power source and the external system; and a third DC-to-DC converter configured to regulate a third voltage between the external system and the ultracapacitor module.

In some aspects, the techniques described herein relate to a tender system, further including: An interface module configured to be an application programming interface between the external system and the tender system.

In some aspects, the techniques described herein relate to a tender system, wherein the method further includes: receiving information indicative a startup from the external system; and if the voltage of the ultracapacitor module is above the voltage threshold, transferring the energy supply to the external system.

In some aspects, the techniques described herein relate to a tender system including: an ultracapacitor module including at least one ultracapacitor, wherein the ultracapacitor module is electrically coupled to an external system, such that the ultracapacitor module provides power to the external system for selectively powering the external system; a power source electrically coupled to the ultracapacitor module the power source storing an energy supply and providing at least a portion of the energy supply to the ultracapacitor module; one or more DC-to-DC converters for regulating a plurality of voltages between the ultracapacitor module, the power source, and the external system; and one or more non-transitory computer-readable media including computer-executable instructions that, when executed by at least one processor, perform a method of managing the ultracapacitor module and the power source, the method including: receiving, from the external system, information indicative of a startup; measuring an energy level of the ultracapacitor module to determine if the energy level is above a predetermined voltage threshold; if the energy level is above the predetermined voltage threshold, transferring at least a portion of the energy supply to the external system; and charging the ultracapacitor module to at least the predetermined voltage threshold.

In some aspects, the techniques described herein relate to a tender system, wherein the method further includes: transferring at least a portion of the energy supply of the power source to the external system.

In some aspects, the techniques described herein relate to a tender system, further including: an interface module communicatively connected to an onboard computer of the external system.

In some aspects, the techniques described herein relate to a tender system, wherein the method further includes: monitoring at least one of a state of health or a state of charge of the power source; and if at least one of the state of charge or the state of health falls below a predetermined threshold, transmitting information indicative of a last start up to the external system.

In some aspects, the techniques described herein relate to a tender system, wherein the one or more DC-to-DC converters include: a buck-type DC-to-DC converter and a boost-type DC-to-DC converter.

In some aspects, the techniques described herein relate to a tender system, wherein the method further includes: monitoring a state of the external system; and if the external system is in a powered-off state, entering hibernation mode for a predetermined interval.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present disclosure will be apparent from the following detailed description of the embodiments and the accompanying drawing figures.

### BRIEF DESCRIPTION OF THE DRAWING FIGURES

Embodiments of the present disclosure are described in detail below with reference to the attached drawing figures, wherein:

FIG. 1 illustrates an exemplary hardware system, in accordance with embodiments of the invention;

FIG. 2 illustrates an exemplary tender system, in accordance with embodiments of the invention;

FIG. 3. illustrates an exemplary tender system, in accordance with embodiments of the invention;

FIG. 4 illustrates an exemplary flow diagram, in accordance with embodiments of the invention; and

FIG. 5 illustrates an exemplary flow diagram, in accordance with embodiments of the invention.

The drawing figures do not limit the present disclosure to the specific embodiments disclosed and described herein. The drawings are not necessarily to scale, emphasis instead being placed upon clearly illustrating the principles of the present disclosure.

### DETAILED DESCRIPTION

The following detailed description references the accompanying drawings that illustrate specific embodiments in which the present disclosure can be practiced. The embodiments are intended to describe aspects of the present disclosure in sufficient detail to enable those skilled in the art to practice the present disclosure. Other embodiments can be utilized and changes can be made without departing from the scope of the present disclosure. The following detailed description is, therefore, not to be taken in a limiting sense. The scope of the present disclosure is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Aspects of the present disclosure provide a tender system. A tender system is a system in which a power source is used to charge and maintain the energy supply of an ultracapacitor module, the ultracapacitor module serving as an energy supply to an external system (discussed further below). One or more ultracapacitors of the ultracapacitor module may be subject to a voltage range, referred to as a charge window, within which the voltages of the one or more ultracapacitors may be maintained. The charge window comprises a first voltage threshold and a second voltage threshold, the ultracapacitors being charged such that the voltages of the one or more ultracapacitors remain between the first and second voltage thresholds. As described above, the ultracapacitor module is connected to a power source, and if the one or more ultracapacitors of the ultracapacitor module discharges to a voltage less than the first voltage threshold, the power source charges the ultracapacitor module up to the second voltage threshold. A DC-to-DC converter is connected between the ultracapacitor module and the power source such that any current running between the power source and the ultracapacitor module travels through the DC-to-DC converter. The DC-to-DC converter may regulate the current being inputted into the ultracapacitor module by decreasing and/or increasing the voltage to be compatible with desired, needed, or required voltage of the ultracapacitors of the ultracapacitor module.

Aspects of the present disclosure may further include an external system coupled to the tender system through the ultracapacitor module, the ultracapacitor module providing energy to the external system. For example, the external system may be a vehicle (e.g., car, truck, boat, train) connected to and utilizing the ultracapacitor module and the tender system for powering on the vehicle (e.g., for operational use). The external system may include an external controller and an external charging module for facilitating the transfer of energy between the ultracapacitor module and the external system. For example, the external system may be a vehicle including a controller and an alternator, where the controller receives and transmits instructions from and to the tender system for charging the ultracapacitor module using the alternator.

A power source serves as an energy supply for the ultracapacitor module such that the power source charges/maintains the energy supply of the ultracapacitor module. As discussed above, the external system may include an external charging module for recharging the ultracapacitor module and/or the power source when the external charging module is powered on for operational use. For example, the charging module may be an alternator of a car, where, when the car is powered on and the alternator is running (i.e., in operational use), the alternator may charge the ultracapacitor module and the power source.

Aspects of the present disclosure further include the tender system comprising a controller for monitoring the ultracapacitor module and the power source and facilitating energy transfer between the ultracapacitor module, the power source, and the external system. For example, the controller may facilitate the selective powering of the one or more DC-to-DC converters. The controller of the tender system is communicatively coupled to the external controller of the external system for facilitating the transfer of instructions and status information.

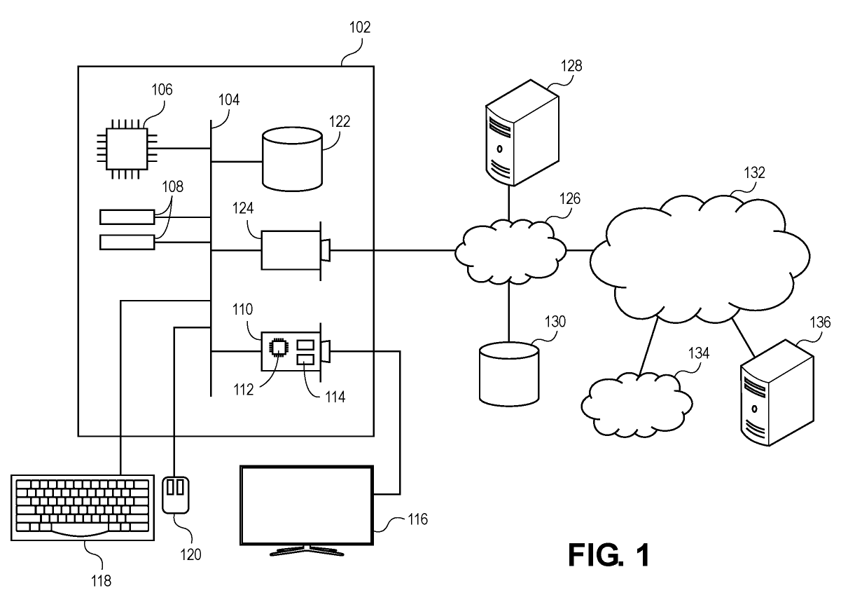

FIG. 1 illustrates an exemplary hardware platform relating to some embodiments of the present disclosure. Computer 102 can be a desktop computer, a laptop computer, a server computer, a mobile device such as a smartphone or tablet, or any other form factor of general- or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple busses or components may communicate with each other directly. Connected to system bus 104 is central processing unit (CPU) 106. Also attached to system bus 104 are one or more random-access memory (RAM) modules 108. Also attached to system bus 104 is graphics card 110. In some embodiments, graphics card 110 may not be a physically separate card, but rather may be integrated into the motherboard or the CPU 106. In some embodiments, graphics card 110 has a separate graphics-processing unit (GPU) 112, which can be used for graphics processing or for general purpose computing (GPGPU). Also on graphics card 110 is GPU memory 114. Connected (directly or indirectly) to graphics card 110 is display 116 for user interaction. In some embodiments no display is present, while in others it is integrated into computer 102. Similarly, peripherals such as keyboard 118 and mouse 120 are connected to system bus 104. Like display 116, these peripherals may be integrated into computer 102 or absent. Also connected to system bus 104 is local storage 122, which may be any form of computer-readable media, and may be internally installed in computer 102 or externally and removably attached.

Such non-transitory computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, network interface card (NIC) 124 is also attached to system bus 104 and allows computer 102 to communicate over a network such as network 126. NIC 124 can be any form of network interface known in the art, such as Ethernet, ATM, fiber, Bluetooth®, or Wi-Fi (i.e., the IEEE 802.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data such as computer 128, accessible on a local network such as local network 126, or remotely accessible over Internet 132. Local network 126 is in turn connected to Internet 132, which connects many networks such as local network 126, remote network 134 or directly attached computers such as computer 136. In some embodiments, computer 102 can itself be directly connected to Internet 132.

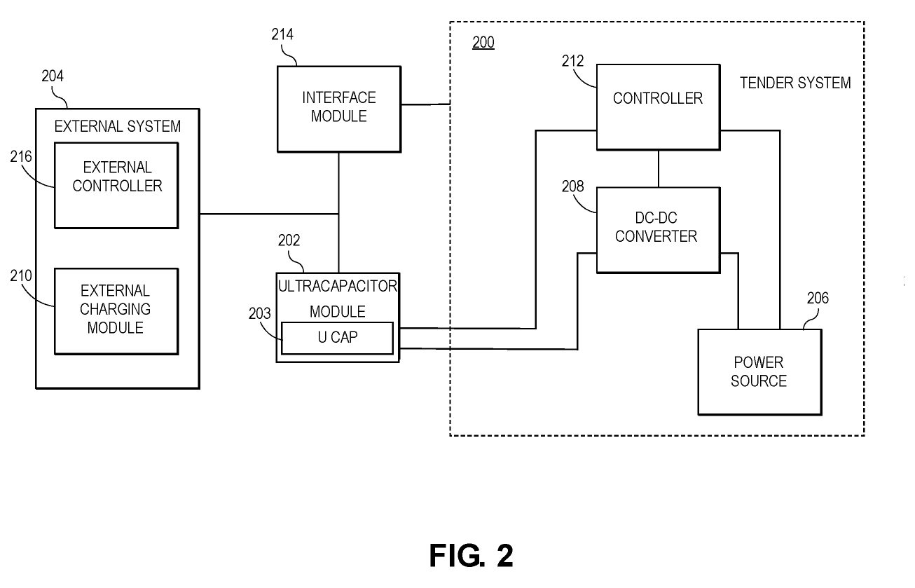

FIG. 2 illustrates an exemplary ultracapacitor tender system, in accordance with embodiments of the invention and generally referred to by reference numeral 200. As described above, tender system 200 tenders an ultracapacitor module, meaning it charges the ultracapacitors 203 of the ultracapacitor module and maintains the voltage of the ultracapacitors 203 of the ultracapacitor module. Tender system 200 is electrically connected to an ultracapacitor module, the ultracapacitor module for providing energy to external systems. Tender system 200 includes a power source for maintaining the energy stores of the ultracapacitor module by transferring energy to the ultracapacitor module to maintain the one or more ultracapacitors 203 of the ultracapacitor module within a voltage window. A controller, such as a microcontroller, may facilitate energy transfers between the power source, the ultracapacitor module, and external systems and monitor the status of tender system 200 to ensure the appropriate energy levels are being maintained for the power source and ultracapacitor module.

Tender system 200 comprises power source 206, DC-to-DC converter 208, and controller 212. Tender system 200 is coupled to ultracapacitor module 202, where ultracapacitor module 202 selectively provides power to external system 204. External system 204 may be any device or system now known or later developed, including, but not limited to, an automobile, a locomotive, a snowmobile, a utility task vehicle (UTV), an all-terrain vehicle (ATV), a golf cart, a recreational vehicle, a power-driven boat, and similar vehicle systems. For example, external system 204 may be a UTV connected to tender system 200 through ultracapacitor module 202, where tender system 200 provides and maintains the energy supply of ultracapacitor module 202 for powering the UTV.

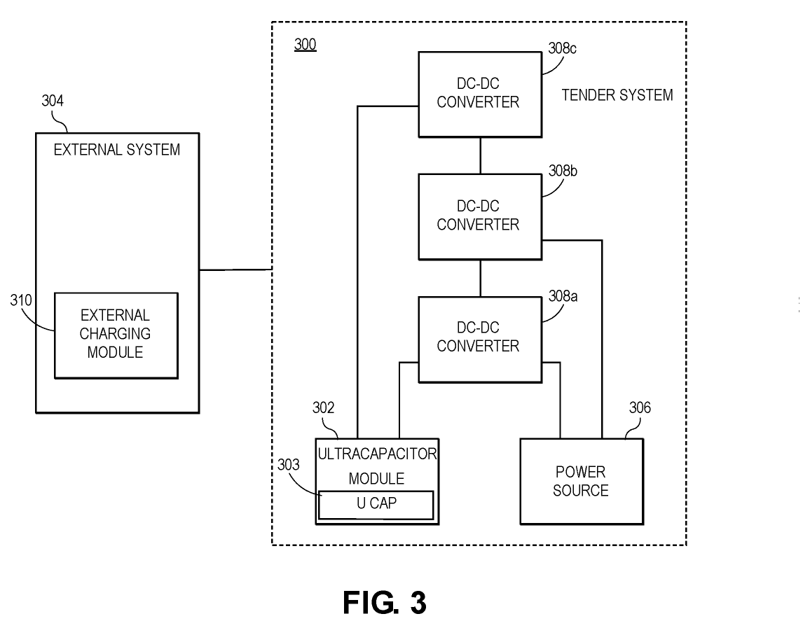

In some embodiments, as depicted in FIG. 2, tender system 200 is retrofitted to one or more additional systems. For example, tender system 200 may include DC-to-DC converter 208, power source 206, and controller 212. Accordingly, tender system 200 may electrically connect to ultracapacitor module 202, where ultracapacitor module 202 is connected to external system 204. In such embodiments, tender system 200 may be isolated from external system 204 such that no direct electrical connection is present between tender system 200 and external system 204. In other embodiments, such as is depicted in FIG. 3, a tender system is an all-in-one system such that an ultracapacitor module is included in the tender system. For example, a tender system may include an ultracapacitor module as well as one or more DC-to-DC converters, a power source, and a controller. Accordingly, the tender system may establish a direct electrical connection with an external system.

In some embodiments, as mentioned above, tender system 200 is electrically coupled to ultracapacitor module 202. Ultracapacitor module 202 includes one or more ultracapacitors 203. Ultracapacitor module 202 may include any number of additional components, including circuitry, a controller, and wiring. Ultracapacitor module 202 may include a singular ultracapacitor 203 or a plurality of ultracapacitors 203. The ultracapacitors 203 of ultracapacitor module 202 store energy and provide the stored energy to external system 204. Further, one or more ultracapacitors 203 of ultracapacitor module 202 discharge and recharge. For example, when not in use, ultracapacitor module 202 may drop in voltage at a rate greater than zero. Accordingly, ultracapacitor module 202 may be recharged (by tender system 200, for example) such that the energy supply/voltage of ultracapacitor module 202 increases. The energy supply of ultracapacitor module 202 is maintained such that the voltage of ultracapacitor module 202 remains in a voltage window, the voltage window including a first voltage threshold and a second voltage threshold which may correspond to a minimum voltage value before initiating recharging and a maximum voltage value before stopping recharging ultracapacitor module 202, respectively.

Ultracapacitor module 202 may include any type of ultracapacitor now known or later developed, including, but not limited to, electrostatic double-layer capacitors, electrochemical pseudo-capacitors, hybrid capacitors, and any other ultracapacitor types. In some embodiments, ultracapacitor module 202 may contain a singular type of ultracapacitor. In other embodiments, ultracapacitor module 202 may contain multiple types of ultracapacitors 203. In a similar fashion, ultracapacitor module 202 may include a single ultracapacitor or a plurality of ultracapacitors 203, such that the ultracapacitor module 202 includes at least one ultracapacitor.

Ultracapacitor module 202 includes one or more terminal posts for establishing electrical connections. In some embodiments, ultracapacitor module 202 may include a two-post electrical connection. For example, ultracapacitor module 202 may include a positive terminal and a negative terminal. In some embodiments, ultracapacitor module 202 may include a three-post electrical connection. For example, ultracapacitor module 202 may include a positive terminal, a negative terminal, and a charging terminal for charging ultracapacitor module 202.

In some embodiments, the posts (e.g., two posts, three posts, etc.) of ultracapacitor module 202 are used for electrically connecting ultracapacitor module 202 to DC-to-DC converter 208 and external system 204. For example, ultracapacitor module 202 may electrically connect to DC-to-DC converter 208 and external system 204 through a positive terminal and a negative terminal. In some embodiments, the posts of ultracapacitor module 202 are used for charging and discharging ultracapacitor module 202, such that the posts may be used to establish an electrical connection (for example, with power source 206) to increase the energy supply of ultracapacitor module 202 and/or decrease the energy supply of ultracapacitor module 202.

As mentioned above, ultracapacitor module 202 serves as a power source for external system 204. For example, energy may be transferred from ultracapacitor module 202 to a starting system of external system 204, where the energy is used to facilitate the starting of external system 204. Accordingly, as external system 204 uses the energy stores of ultracapacitor module 202, the voltage of ultracapacitor module 202 decreases. The energy level of ultracapacitor module 202 may then be increased and/or maintained using power source 206 and/or external charging modules, such as external charging module 210.

Power source 206 may be any type of power source now known or later developed, including, but not limited to, a battery, a lithium-ion (LiO) battery, a lithium iron phosphate (LiFePO4) battery, a lead-acid battery, a rechargeable battery, an electrochemical cell, an electrochemical energy storage device, a solid-state battery, and a USB charging device. For example, power source 206 may be a two-terminal rechargeable battery. Power source 206 may include a singular component, such as a singular battery, or a plurality of components, such as a plurality of batteries.

In some embodiments, power source 206 maintains the energy supply of ultracapacitor module 202. For example, when the energy supply of ultracapacitor module 202 decreases due to use by external system 204, power source 206 may transfer energy to ultracapacitor module 202 to raise the voltage to meet a predetermined threshold. For another example, when the energy supply of ultracapacitor module 202 decreases due to lack of use of ultracapacitor module 202, power source 206 may charge ultracapacitor module 202 to meet a predetermined threshold. For another example, power source 206 may maintain ultracapacitor module 202 at a “ready-to-start” voltage, such that ultracapacitor module 202 is maintained at a voltage capable of starting up external system 204, such as 12.5V.

In some embodiments, power source 206 provides energy directly to external system 204. For example, external system 204 may include an accessory mode, where, when external system 204 is in accessory mode, external system 204 sources energy from power source 206. By way of another example, external system 204 may include external controller 216, where external controller 216 may manage the energy resources being used by external system 204. When external controller 216 is manually and/or automatically directed to source energy from power source 206, external controller 216 may provide instructions to controller 212 of tender system 200. Accordingly, controller 212 may direct tender system 200 to provide energy directly from power source 206 to external system 204.

In some embodiments, external system 204 includes external charging module 210. At a high level, external charging module 210 may be configured to recharge ultracapacitor module 202 and/or power source 206. For example, external system 204 may be an automobile and external charging module 210 may be an alternator of the automobile. Accordingly, after external system 204 has been turned on, the alternator may feed energy back to ultracapacitor module 202 and power source 206.

In some embodiments, external charging module 210 selectively charges ultracapacitor module 202, power source 206, or both. For example, external controller 216 may provide instruction information to tender system 200 and/or external charging module 210 to selectively charge ultracapacitor module 202 or power source 206. In some embodiments, external charging module 210 provides information indicative of the order in which ultracapacitor module 202 and power source 206 are to be charged. For example, external controller 216 may instruct tender system 200 and/or external charging module 210 to charge power source 206 before ultracapacitor module 202, or vice versa.

In some embodiments, tender system 200 manages the transfer of energy between ultracapacitor module 202, power source 206, and external system 204. In some embodiments, DC-to-DC converter 208 facilitates the transfer of energy between external system 204, ultracapacitor module 202, and power source 206. Generally, DC-to-DC converter 208 may be any type of DC-to-DC converter now known or later developed, including, but not limited to, a boost-type DC-to-DC converter, a buck-type DC-to-DC converter, a buck-boost type DC-to-DC converter, and the like. DC-to-DC converter 208 may include one or more gates for the selective powering of DC-to-DC converter 208. For example, DC-to-DC converter 208 may include a gate, where switching on the gate results in energy transfer between power source 206 and ultracapacitor module 202, and switching off the gate prevents energy transfer between power source 206 and ultracapacitor module 202.

In some embodiments, DC-to-DC converter 208 moves energy between power source 206 and ultracapacitor module 202. Put another way, energy transfers between power source 206 and ultracapacitor module 202 through DC-to-DC converter 208. In such embodiments, DC-to-DC converter 208 modifies the output voltage of power source 206 to be a proper input voltage for ultracapacitor module 202 and vice versa. For example, if power source 206 outputs a voltage exceeding the rated voltage for ultracapacitor module 202, DC-to-DC converter 208 may lower the input voltage of ultracapacitor module 202 such that it’s within the rating of ultracapacitor module 202. Doing so may prevent improper voltage levels from being input into power source 206 and ultracapacitor module 202, preventing damage and preserving the lifespan of both power source 206 and ultracapacitor module 202.

In some embodiments, DC-to-DC converter 208 regulates the incoming voltage from external system 204 into ultracapacitor module 202. Similarly to power source 206, external system 204 may differ in voltage compared to ultracapacitor module 202, where if the voltage coming directly from external system 204 were to be input into ultracapacitor module 202, the voltage may damage or shorten the lifespan of ultracapacitor module 202. As such, DC-to-DC converter 208 may regulate the voltage received from external system 204 by increasing and/or decreasing the voltage being input into ultracapacitor module 202 to be compatible with the voltage rating of ultracapacitor module 202.

Similarly, in some embodiments, DC-to-DC converter 208 regulates the incoming voltage from external system 204 into power source 206. As mentioned above, external system 204 may provide energy to power source 206, such as through external charging module 210. But, similarly to ultracapacitor module 202 and external system 204, power source 206 and external system 204 may have incompatible voltage ratings where if the voltage of external system 204 was input into power source 206, power source 206 may incur damage that shortens the lifespan of power source 206. As such, energy received from external system 204 to be input into power source 206 may first pass through DC-to-DC converter 208 in order to regulate the voltage being input into power source 206. For example, the voltage received from external system 204 may be stepped down by DC-to-DC converter 208 such that the voltage does not exceed the maximum voltage that power source 206 is rated for.

It is noted herein that external system 204 may output direct current (DC) and/or alternating current (AC) for charging ultracapacitor module 202 and/or power source 206. Accordingly, in some embodiments, tender system 200 includes an AC-to-DC converter. The AC-to-DC converter converts alternating current received from external charging module 210 into direct current compatible with ultracapacitor module 202 and/or power source 206.

In some embodiments, tender system 200 monitors and controls ultracapacitor module 202, external system 204, and power source 206. For example, tender system 200 may include logic elements (as discussed below) for monitoring ultracapacitor module 202 and power source 206 and transmitting and receiving communications to and from external system 204. For another example, tender system 200 may include logic elements to determine when ultracapacitor module 202 and power source 206 need to be recharged. Accordingly, in some embodiments, tender system 200 includes controller 212. Controller 212 may be a microcontroller, or a similar device. Controller 212 may include a processor, memory, and one or more non-transitory computer-readable media including computer-executable instructions to be executed by processor.

In some embodiments, controller 212 is communicatively coupled to DC-to-DC converter 208, ultracapacitor module 202, power source 206, and interface module 214. Controller 212 may establish communication connections (with, for example, external controller 216 of external system 204) through wired connections and/or wireless connections. For example, controller 212 may be communicatively coupled to external system 204 via a wired connection, a wireless connection, a Bluetooth connection, a Wi-Fi connection, a cellular connection, and any other form of connection.

In some embodiments, controller 212 monitors the statuses of ultracapacitor module 202, external system 204, and/or power source 206. For example, controller 212 may monitor the state of charge (SOC), state of health (SOH), powering status, voltage, temperature, and any other metric of ultracapacitor module 202, external system 204, and power source 206. Controller 212 may store historical data associated with ultracapacitor module 202, external system 204, and power source 206 to compare current statuses of ultracapacitor module 202, external system 204, and power source 206 with past data for monitoring purposes. By reading and monitoring the statuses of ultracapacitor module 202, external system 204, and power source 206, ultracapacitor module 202 may determine further actions to occur. For example, if monitoring ultracapacitor module 202 reveals that the voltage of ultracapacitor module 202 has fallen below a predetermined first voltage threshold, controller 212 may determine that the voltage of ultracapacitor module 202 needs to be raised. Accordingly, controller 212 may then transmit an instruction to external system 204 to transfer energy to tender system 200.

For another example, controller 212 may determine and/or monitor the health (e.g., SOH) of the power source 206 and/or ultracapacitor module 202. Accordingly, in some embodiments, controller 212 transmits to external system 204 and a user via interface module 214 information indicative of ultracapacitor module 202 and/or components of tender system 200 needing replacement or repairs. For example, controller 212 may transmit to interface module 214 information indicative of power source 206 no longer holding a charge. Determining and monitoring SOH may prove advantageous, as a user is provided an indication of a problem before the problem is realized during startup, for example. In some embodiments, controller 212 transmits to a user and/or external system 204 information indicative of ultracapacitor module 202 and/or power source 206 only being available for one more energy transfer. Accordingly, a user of external system 204 may then know to seek out alternative power sources. This may prevent external system 204 from relying on energy provided by ultracapacitor module 202 and tender system 200 when ultracapacitor module 202 and tender system 200 are unable to provide an energy supply.

In some embodiments, a plurality of parameters is input into controller 212, including parameters related to ultracapacitor module 202, power source 206, DC-to-DC converter 208, and external system 204. For example, parameters inputted into and stored by controller 212 may include, but are not limited to, capacity/ampere hours (Ah), voltage thresholds (e.g., first voltage thresholds and second voltage thresholds), float voltages, absorption voltages, and the like. For example, the first voltage threshold and the second voltage threshold for the voltage of the ultracapacitor module 202 may be inputted into and stored by controller 212. Accordingly, in some embodiments, controller 212 compares the current voltage of the ultracapacitor module 202 to the first voltage threshold and second voltage threshold when determining whether to instruct tender system 200 to charge ultracapacitor module 202.

In some embodiments, controller 212 facilitates energy transfer between ultracapacitor module 202 and power source 206. For example, controller 212 may start and/or stop the transfer of energy between ultracapacitor module 202 and power source 206. For another example (and continuing the example above), if controller 212 determines that the voltage of ultracapacitor module 202 is below a first voltage threshold, controller 212 may cause the transfer of power from power source 206 to ultracapacitor module 202.

In some embodiments, in order to facilitate energy transfer between ultracapacitor module 202 and power source 206, controller 212 transmits to DC-to-DC converter 208 instructions for DC-to-DC converter 208 to transfer energy between ultracapacitor module 202 and power source 206. For example, controller 212 may transmit instructions to DC-to-DC converter 208 to power on for operational use one or more gates/switches of DC-to-DC converter 208 to start the transfer of energy between ultracapacitor module 202 and power source 206. Accordingly, controller 212 may power off (e.g., from operational use) one or more gates/switches of DC-to-DC converter 208 when a predetermined second voltage threshold (such as a voltage ceiling) of ultracapacitor module 202 is reached. To determine when to open/close the gates of DC-to-DC converter 208, controller 212 may monitor the SOC of both ultracapacitor module 202 and power source 206.

In some embodiments, controller 212 facilitates the charging of ultracapacitor module 202 and power source 206 by external system 204, such as through external charging module 210. For example, controller 212 may transmit instructions indicative of external charging module 210 starting, stopping, and/or modifying the charging of ultracapacitor module 202 and/or power source 206 by external charging module 210. Controller 212 may provide instructions for selectively powering/switching the gates of DC-to-DC converter 208 to regulate the incoming voltage from external charging module 210. For example, if the voltage coming from external charging module 210 is incompatible with the voltage of ultracapacitor module 202 and/or power source 206, controller 212 may instruct DC-to-DC converter 208 to modify the incoming voltage to be compatible with ultracapacitor module 202 and/or power source 206.

In some embodiments, controller 212 is communicatively coupled to interface module 214 to provide information and instructions associated with tender system 200, ultracapacitor module 202, a user, and/or external system 204. For example, interface module 214 may be an interface between controller 212 and external controller 216. In some embodiments, interface module 214 is an API between external controller 216 and controller 212. For example, instructions may be transmitted and received between external controller 216 and controller 212 through interface module 214. For example, external controller 216 may provide override instructions to controller 212 when controller 212 indicates that power source 206 has an energy supply below a certain threshold. Accordingly, controller 212 may then charge up ultracapacitor module 202 using power source 206 despite the low voltage of power source 206. In some embodiments, interface module 214 translates communications between controller 212 and external system 204. For example, interface module 214 may translate instructions transmitted by controller 212 such that the instructions are in an executable format as specified by external system 204.

Interface module 214 may be any interface now known or later developed, including, but not limited to, an LCD screen, buttons, an LED screen, lights, flashes, sounds, and the like. For example, interface module 214 may include a status button, where actuating the button causes controller 212 to transmit the status of ultracapacitor module 202 and power source 206, such as the SOC of ultracapacitor module 202. In some embodiments, interface module 214 interfaces with one or more devices (such as controller 212 of external system 204) through Wi-Fi, Bluetooth, email, SMS messaging, cellular networks, a wired connection, or any other means. For example, interface module 214 may communicate with external controller 216 of external system 204 to indicate that there is a single startup left, ultracapacitor module 202 is ready to start up, or ultracapacitor module 202 is charging. For another example, controller 212 may initiate the sending of an email to external system 204 through 214 with information indicative of power source 206 reaching the end the lifespan of power source 206. By interfacing with controller 212 through interface module 214, external controller 216 may be used to display any type of information associated with ultracapacitor module 202 and tender system 200, provide information indicative of the status of components of tender system 200 and ultracapacitor module 202, and/or instruct ultracapacitor module 202 to provide energy to external system 204.

FIG. 3. illustrates an exemplary ultracapacitor tender system, in accordance with embodiments of the invention and generally referred to by reference numeral 300. Generally, the components of tender system 300 substantially relate to the components of tender system 200 depicted in FIG. 2. In some embodiments, power source 306, generally related to power source 206 depicted in FIG. 2, provides energy to and maintains the energy of one or more ultracapacitors 303 of ultracapacitor module 302, generally related to one or more ultracapacitors 203 and ultracapacitor module 202 depicted in FIG. 2. For example, if the voltage of ultracapacitor module 302 falls below a voltage window for ultracapacitor module 302, power source 306 may provide energy to one or more ultracapacitors 303 of ultracapacitor module 302. In some embodiments, power source 306 may provide energy to external system 304, generally related to external system 204 depicted in FIG. 2.

In some embodiments, tender system 300 includes ultracapacitor module 302, rather than ultracapacitor module 302 being a separate module from tender system 300, as exemplified by FIG. 2. In some embodiments, one or more ultracapacitors 303 of ultracapacitor module 302 provide energy to external system 304. For example, external system 304 may use energy provided by one or more ultracapacitors 303 of ultracapacitor module 302 to start up one or more subsystems of external system 304, such as an engine starter. For another example, external system 304 may use energy provided by one or more ultracapacitors 303 of ultracapacitor module 302 to power one or more accessories of external system 304.

In some embodiments, external system 304 includes an external charging module 310, generally relating to external charging module 210 depicted in FIG. 2. In some embodiments, external charging module 310 provides energy to one or more ultracapacitors 303 of ultracapacitor module 302 and/or power source 306 when external charging module 310 is in a powered-on state. Therefore, if external system 304 utilizes energy from ultracapacitor module 302 to start up external system 304, external charging module to 310 may then recharge one or more ultracapacitors 303 of ultracapacitor module 302. Additionally, external charging module 310 may be configured to recharge power source 306 to restore any energy used by power source 306 to charge one or more ultracapacitors 303 of ultracapacitor module 302.

In some embodiments, tender system 300 includes a plurality of DC-to-DC converters rather than a singular DC-to-DC converter to facilitate energy transfer between external system 304, ultracapacitor module 302, and power source 306. For example, tender system 300 may include DC-to-DC converter 308a, DC-to-DC converter 308b, and DC-to-DC converter 308c, all of which generally correspond to DC-to-DC converter 208 depicted in FIG. 2.

In some embodiments, DC-to-DC converter 308a facilitates the transfer of energy between power source 306 and ultracapacitor module 302. For example, DC-to-DC converter 308a may regulate the voltage outputted by power source 306 such that the input voltage to ultracapacitor module 302 is a voltage compatible with one or more ultracapacitors 303 of ultracapacitor module 302. For example, if ultracapacitor module 302 has a maximum voltage rating of 15 volts, DC-to-DC converter 308a may step down the voltage provided by power source 306 if the voltage provided by power source 306 is greater than 15 volts. Doing so may prevent damage from occurring to ultracapacitor module 302.

In some embodiments DC-to-DC converter 308b facilitates the transfer of energy between external system 304 and power source 306. For example, energy provided to external system 304 by power source 306 may pass through DC-to-DC converter 308b before being input into external system 304. For another example, energy provided to power source 306 by external system 304 may pass through DC-to-DC converter 308b before being received by power source 306. As such, DC-to-DC converter 308b may ensure both external system 304 and power source 306 are receiving compatible voltages.

In some embodiments DC-to-DC converter 308c facilitates the transfer of energy between external system 304 and ultracapacitor module 302. For example, energy provided to external system 304 by ultracapacitor module 302 may pass through DC-to-DC converter 308c before being received by external system 304. For another example, energy provided to ultracapacitor module 302 by external system 304 may pass through DC-to-DC converter 308c before being input into ultracapacitor module 302. As such, DC-to-DC converter 308c may ensure both external system 304 and one or more ultracapacitors 303 of ultracapacitor module 302 are receiving compatible voltages.

In some embodiments, as opposed to tender system 200 depicted in FIG. 2, tender system 300 utilizes a plurality of DC-to-DC converters and/or external system 304 for regulating and facilitating the functioning of ultracapacitor module 302 and power source 306, as opposed to using a controller, such as controller 212. For example, tender system 300 may include additional components (such as voltage comparators, operational amplifiers, and field-effect transistors) that allows for DC-to-DC converter 308a, DC-to-DC converter 308b, and DC-to-DC converter 308c to regulate energy transfer without use of a controller.

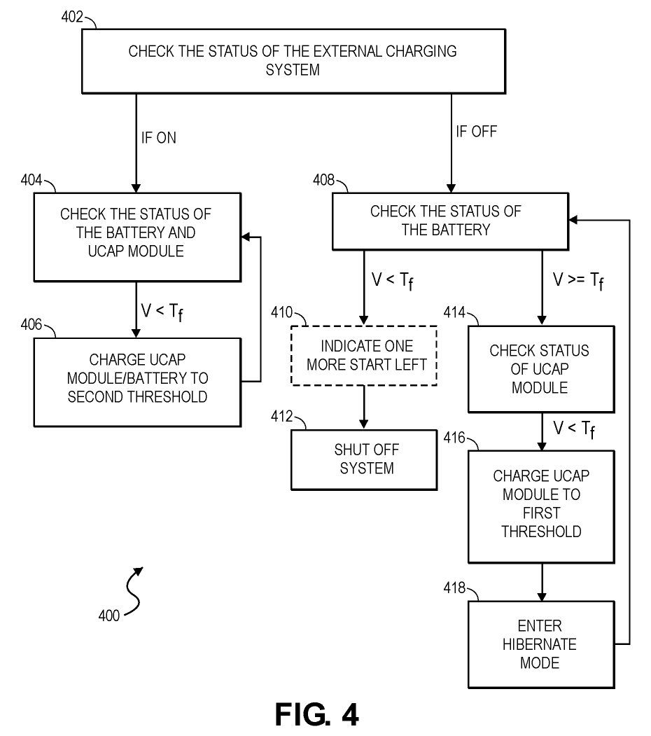

FIG. 4 illustrates an exemplary flow diagram for tendering an ultracapacitor module and a power source, in accordance with embodiments of the invention and generally referred to by reference numeral 400. At a high level, method 400 monitors the statuses of an external charging system, an ultracapacitor module, and a power source to determine the appropriate times for charging the ultracapacitor module and the power source. For example, under certain conditions in relation to method 400, the power source and the ultracapacitor module are charged, and under other conditions, the system enters hibernation mode, where the power source and ultracapacitor module are left to discharge.

At step 402, the status of the external charging system is checked. Any number of status items of the external charging system may be checked. For example, the type of current being provided by the external charging system may be checked, or the health of the external charging system may be checked. In some embodiments, the external charging system may be checked to determine if the external charging system is in a powered-on state or a powered-off state. To elaborate, the external charging system (which may be generally related to external charging module 210 depicted in FIG. 2) may be in a powered-on state, such that the external charging system may provide energy to the ultracapacitor module and the power source. Conversely, the external charging system may be in a powered-off state such that the external charging system may not be able to provide energy to the ultracapacitor module or the power source.

At step 404, if the external charging system is determined to be in a powered on state, the statuses of the power source and the ultracapacitor module are checked. Similarly to the external charging system, any number of status items of the power source and the ultracapacitor module may be checked. For example, the SOH of the power source and/or the ultracapacitor module may be checked. In some embodiments, the SOC of the power source and/or the ultracapacitor module are checked. For example, the voltages of both the power source and the ultracapacitor module may be measured to determine if the voltages fall below or above a first voltage threshold.

At step 406, if the measured voltage of the ultracapacitor module and/or the power source falls below the first voltage threshold, the component(s) falling below the first voltage threshold are charged up to a second voltage threshold. In some embodiments, the ultracapacitor module and/or the power source are charged by the external charging system. As noted above for FIGS. 2-3, the voltage being received by the system from the external charging system may be modified to be compatible with the power source and the ultracapacitor module. For example, the energy received from the external charging system may pass through a DC-to-DC converter before being provided to the ultracapacitor module and/or the power source, where the DC-to-DC converter steps up or steps down the voltage to a voltage compatible with the voltage rating for the ultracapacitor module and/or the power source.

It is noted herein that the ultracapacitor module and the power source may have differing first voltage thresholds and second voltage thresholds. For example, the ultracapacitor module may have a lower first voltage threshold than the power source such that the ultracapacitor module is allowed to discharge more before the energy levels are restored via charging. Additionally, as mentioned above with regard to FIGS. 2-3, any energy transferred between the power source and the ultracapacitor module may first pass through a DC-to-DC converter to ensure the proper voltages are received by the ultracapacitor module and the power source.

Upon charging the ultracapacitor module and/or the power source, the status of the power source and the ultracapacitor module are periodically monitored to determine if additional charging is required. The monitoring period may be any predetermined time frame. For example, the status of the power source and the ultracapacitor module may be monitored every 3 minutes to determine if one or both of the ultracapacitor module and the power source need to be charged. In some embodiments, after charging the ultracapacitor module and/or the power source to a second voltage threshold, the statuses of the external charging system are checked, such is done in step 402, to determine if the external charging system is still in a powered on state and operational for providing energy to the ultracapacitor module and the power source.

In step 408, if it is determined that the external charging system is in a powered-off state, the status of the power source is checked. As mentioned above, any number of statuses of the power source may be checked, including the SOH of the power source and the SOC of the power source. In some embodiments, the charge of the power source is compared to a first voltage threshold. For example, the power source may be compared to a first voltage threshold value of 0 volts, thus checking if the power source is fully discharged. For another example, the power source may be compared to a first voltage threshold value where the first voltage threshold value represents a value where the power source would be fully discharged if power source were to charge the ultracapacitor module one more time.

At optional step 410, if it is determined that the voltage of the power source falls below the first voltage threshold value, information indicative of the power source and ultracapacitor module only having energy to provide one more start to an external system is transmitted. For example, as described above with regard to FIG. 2, if the ultracapacitor module and the power source are connected to a UTV, the controller connected to the ultracapacitor module and the power source may indicate to the onboard system of the UTV that the UTV may start up one more time using the ultracapacitor module and the power source. In some embodiments, an interface module, such as interface module 214 depicted in FIG. 2, receives a transmission of information indicative of a final start and transmits the information to external controller 216 of external system 204. In some embodiments, an interface module provides information using lights, sounds, and any other sensory means.

At step 412, if it is determined that the voltage of the power source falls below the first voltage threshold value of the power source, the power source and/or ultracapacitor module system are powered off (e.g., from operational use). For example, the power source and/or the ultracapacitor module may be powered off to preserve the life of the power source and or the ultracapacitor module by preventing the power source and the ultracapacitor module from draining to a damaging level. Accordingly, the ultracapacitor module and the power source may need additional charging systems beyond the external charging system to be used again, such as an external AC charging system.

At step 414, if the voltage of the power source is greater than or equal to the first voltage threshold, the status of the ultracapacitor module is checked. As mentioned above, any number of statuses of the ultracapacitor module may be checked, including, but not limited to, the SOH of the ultracapacitor module, the SOC of the ultracapacitor module, and any other statuses. In some embodiments, the SOC of the ultracapacitor module is checked and the voltage of the ultracapacitor module is compared to a first voltage threshold to determine if the voltage of the ultracapacitor module is above or below the first voltage threshold.

At step 416, if the voltage of the ultracapacitor module is less than the first voltage threshold, the ultracapacitor module is charged by the power source until the voltage of the ultracapacitor module reaches the second voltage threshold. For example, if the ultracapacitor module has a defined first voltage threshold of 2V and a second voltage threshold of 15V, if the ultracapacitor module falls below 2V, the ultracapacitor voltage may then be charged up to 15V. If the voltage of the ultracapacitor module is greater than or equal to the first voltage threshold, method 400 may bypass step 416 and go to step 418.

At step 418, hibernation mode is entered. At a high level, hibernation mode may be entered to preserve energy in the system containing the power source and ultracapacitor module when the external charging module is powered off. In some embodiments, when in hibernation mode, the controller attached to the power source and ultracapacitor module enters a low-power mode. The statuses of the power source and the ultracapacitor module may be monitored at a predetermined interval to determine if additional charging is necessary and/or if there may only be a single start left for the external system, given the availability of energy from the power source and the ultracapacitor module. Accordingly, the system containing the power source and ultracapacitor module may enter hibernate mode for a predetermined period of time and then wake up from hibernate mode to check the status of the power source, such as is done in step 408. For example, the system may wake up from hibernate mode every 3 minutes to check the status of the power source. In some embodiments, when waking up from hibernate mode, the system may check the status of the external charging system, such as is described in step 402.

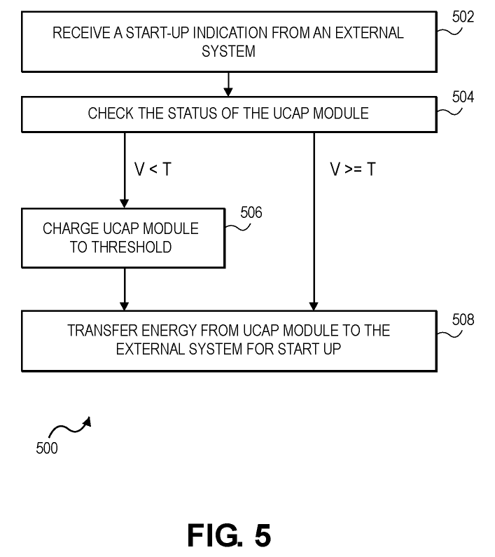

Finally, FIG. 5 illustrates an exemplary flow diagram for using an ultracapacitor tender system for starting up an external system, in accordance with embodiments of the invention and generally referred to by reference numeral 500. Broadly, an ultracapacitor module, such as ultracapacitor module 202, depicted in FIG. 2, is used to start up an external system, such as external system 204, depicted in FIG. 2. Additionally, the ultracapacitor module may be stepped up to a voltage where additional energy may remain in the ultracapacitor module after starting the external system. In such a case, the additional energy is used by the external system before tapping into the power source, which may help to preserve the life of the power source.

At step 502, a startup indication is received from an external system. Generally, the startup indication may be a notice that a user and/or system wants to power on the external system for operational use. For example, the information indicative of a startup may be transmitted when a user turns a knob from a “powered-off” position to a “ready to start” position. In some embodiments, an interface module, such as interface module 214 depicted in FIG. 2, may transmit and receive communications between the external system and a microcontroller attached to the ultra-capacitor module. Accordingly, the interface transmit information indicative of a start up that has been received from the external system to a tendering system.

At step 504, after receiving the information indicative of a startup from the external system, the status of the ultracapacitor module is checked. Any number of statuses may be checked regarding the ultracapacitor module. For example, the SOH of the ultracapacitor module may be checked. In some embodiments, the available energy of the ultracapacitor module is checked to determine if the ultracapacitor module currently has enough energy to start up the external system. Put another way, the voltage of the ultracapacitor module may be compared against a predetermined threshold to determine if the voltage of the ultracapacitor module is above or below the threshold. For example, if the external system requires 12.5 voltages to start up, the voltage of the ultracapacitor module may be checked to determine if the voltage is at least 12.5 volts.

At step 506, if it is determined that the voltage of the ultracapacitor module is less than a predetermined voltage threshold, the ultracapacitor module is charged to a level at or above the threshold. For example, if the threshold is 12.5V and the ultracapacitor module is 12V, the ultracapacitor module may be charged to 13V. For another example, if the threshold is 12.5V in the ultracapacitor module is 12V, the ultracapacitor module may be charged to 12.5V. In some embodiments, a second voltage threshold is specified, where if the ultracapacitor module falls below a first voltage threshold, the ultracapacitor module is then charged up to the second voltage threshold.

In some embodiments, as discussed above with regard to FIGS. 2-4, the ultracapacitor module is charged by an attached power source. For example, the ultracapacitor module may be attached to a rechargeable battery that may provide energy to the ultracapacitor module to bring the voltage of the ultracapacitor module up to a predetermined threshold voltage. In some embodiments, before receiving energy from the power source, the energy passes through a DC-to-DC converter to ensure that a proper voltage is being received by the ultracapacitor module so as to prevent the ultracapacitor module from being damaged.

At step 508, if the voltage of the ultracapacitor module is greater than or equal to the first voltage threshold or the ultracapacitor module has been charged up to the second voltage threshold, energy is then transferred from the ultracapacitor module to the external system for startup. Additionally, as mentioned above, after being used by the external system for startup, the ultracapacitor module may include additional energy that may then be used by the external system before the external system utilizes energy from the power source. This may extend the life of the power source and provide energy at a quicker rate to the external system.

Although the present disclosure has been described with reference to the embodiments illustrated in the attached drawing figures, it is noted that equivalents may be employed and substitutions made herein without departing from the scope of the present disclosure as recited in the claims.

Having thus described various embodiments of the present disclosure, what is claimed as new and desired to be protected by Letters Patent includes the following:

1. A tender system comprising:
a power source electrically coupled to an ultracapacitor module comprising at least one ultracapacitor,
wherein the power source stores an energy supply and provides the energy supply to the ultracapacitor module,
wherein the ultracapacitor module is electrically coupled to an external system, such that the ultracapacitor module provides power to the external system for selectively powering the external system;
a DC-to-DC converter for transferring the energy supply from the power source and to the ultracapacitor module; and
a controller comprising at least one processor and at least one non-transitory computer-readable media comprising computer-executable instructions that, when executed by the at least one processor, perform a method of managing the ultracapacitor module and the power source, the method comprising:
measuring a voltage of the ultracapacitor module;
comparing the voltage of the ultracapacitor module to a voltage threshold; and
if the voltage of the at least one ultracapacitor is less than the voltage threshold, transferring, using the DC-to-DC converter, the energy supply from the power source to the ultracapacitor module.

2. The tender system of claim 1, wherein the method further comprises:
measuring a second voltage of the ultracapacitor module,
wherein the voltage is a first voltage;
comparing the second voltage to a second voltage threshold, wherein the voltage threshold is a first voltage threshold and the second voltage threshold is greater than the first voltage threshold; and
if the second voltage is greater than or equal to the second voltage threshold, stopping transfer of the energy supply from the power source to the ultracapacitor module.

3. The tender system of claim 1, wherein the DC-to-DC converter decreases an energy supply voltage such that the energy supply voltage is less than or equal to a voltage rating of the ultracapacitor module.

4. The tender system of claim 1, further comprising:
a second DC-to-DC converter facilitates a transfer of a recharging energy supply from the external system to the power source,
wherein the DC-to-DC converter is a first DC-to-DC converter.

5. The tender system of claim 1, wherein the power source is at least one of a battery, a lithium-ion (LiO) battery, a lithium iron phosphate (LiFePO4) battery, a lead-acid battery, or a rechargeable battery.

6. The tender system of claim 1, wherein the external system is at least one of an automobile, a locomotive, a snowmobile, a utility task vehicle (UTV), an all-terrain vehicle (ATV), a golf cart, or a recreational vehicle.

7. The tender system of claim 1, wherein the method further comprises:
measuring a power source voltage associated with the power source; and
if the power source voltage falls below a power source voltage threshold, transmitting an indication to the external system.

8. A tender system comprising:
a power source electrically coupled to an ultracapacitor module comprising at least one ultracapacitor, the power source storing an energy supply and providing the energy supply to the ultracapacitor module,
wherein the ultracapacitor module is electrically coupled to an external system, such that the ultracapacitor module provides power to the external system for selectively powering the external system;
one or more DC-to-DC converters for transferring the energy supply from the power source and to the ultracapacitor module; and
one or more non-transitory computer-readable media comprising computer-executable instructions that, when executed by at least one processor, perform a method of managing the ultracapacitor module and the power source, the method comprising:
measuring a voltage of the ultracapacitor module;
comparing the voltage of the ultracapacitor module to a voltage threshold; and
if the voltage of the ultracapacitor module is less than the voltage threshold, transferring, using the one or more DC-to-DC converters, at least a portion of the energy supply from the power source to the ultracapacitor module.

9. The tender system of claim 8, wherein the external system comprises an external charging module configured to provide a second energy supply to at least one of the ultracapacitor module or the power source, wherein the energy supply is a first energy supply.

10. The tender system of claim 9, wherein the external charging module is an alternator.

11. The tender system of claim 8, wherein the method further comprises:
determining a state of the external system; and
if the state of the external system is a powered on state, initiating transfer of a second supply via an external charging module associated with the external system to the ultracapacitor module such that the ultracapacitor module recharges,
wherein the energy supply is a first energy supply.

12. The tender system of claim 8, wherein the one or more DC-to-DC converters comprises:
a first DC-to-DC converter configured to regulate a first voltage between the power source and the ultracapacitor module;
a second DC-to-DC converter configured to regulate a second voltage between the power source and the external system; and
a third DC-to-DC converter configured to regulate a third voltage between the external system and the ultracapacitor module.

13. The tender system of claim 8, further comprising:
An interface module configured to be an application programming interface between the external system and the tender system.

14. The tender system of claim 8, wherein the method further comprises:
receiving information indicative a startup from the external system; and
if the voltage of the ultracapacitor module is above the voltage threshold, transferring the energy supply to the external system.

15. A tender system comprising:
a power source electrically coupled to an ultracapacitor module comprising at least one ultracapacitor, the power source storing an energy supply and providing at least a portion of the energy supply to the ultracapacitor module,
wherein the ultracapacitor module is electrically coupled to an external system, such that the ultracapacitor module provides power to the external system for selectively powering the external system;
one or more DC-to-DC converters for regulating a plurality of voltages between the ultracapacitor module, the power source, and the external system; and
one or more non-transitory computer-readable media comprising computer-executable instructions that, when executed by at least one processor, perform a method of managing the ultracapacitor module and the power source, the method comprising:
receiving, from the external system, information indicative of a startup;
measuring an energy level of the ultracapacitor module to determine if the energy level is above a predetermined voltage threshold;
if the energy level is above the predetermined voltage threshold, transferring at least a portion of the energy supply to the external system; and
charging the ultracapacitor module to at least the predetermined voltage threshold.

16. The tender system of claim 15, wherein the method further comprises:
transferring at least a portion of the energy supply of the power source to the external system.

17. The tender system of claim 15, further comprising:
an interface module communicatively connected to an onboard computer of the external system.

18. The tender system of claim 15, wherein the method further comprises:
monitoring at least one of a state of health or a state of charge of the power source; and
if at least one of the state of charge or the state of health falls below a predetermined threshold, transmitting information indicative of a last start up to the external system.

19. The tender system of claim 15, wherein the one or more DC-to-DC converters comprise:
a buck-type DC-to-DC converter and a boost-type DC-to-DC converter.

20. The tender system of claim 15, wherein the method further comprises:
monitoring a state of the external system; and
if the external system is in a powered-off state, entering hibernation mode for a predetermined interval.
